(19) United States
(12) Patent Application Publication
(10) Pub. No.: US 2007/0024781 A1
(43) Pub. Date: Feb. 1, 2007

(54) Polarization compensation film, display panel assembly and display device having the same

(75) Inventors: Yoon-Seok Choi, Yongin-si (KR); Akira Hirai, Seongnam-si (KR); Jun-Ho Song, Seongnam-si (KR); Seon-Hong Ahn, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/488,314

(22) Filed: Jul. 18, 2006

(30) Foreign Application Priority Data
Jul. 30, 2005 (KR) 2005-69946
Nov. 3, 2005 (KR) 2005-104791
Nov. 3, 2005 (KR) 2005-104795

(51) Int. Cl. G02F 1/1335

(52) U.S. Cl. 349/117

(57) ABSTRACT

A display panel assembly includes a display panel, a first polarizing plate disposed over the display panel, a second polarizing plate disposed under the display panel, and a polarization compensation film disposed over the first polarizing plate. The polarization compensation film includes a polarization prism film and a phase difference film. The polarization prism film divides a natural light wave into an ordinary wave with a first polarization state, and an extraordinary wave with a second polarization state. The phase difference film changes the second polarization state of the extraordinary wave into the first polarization state.

### CROSS-REFERENCE TO RELATED FOREIGN APPLICATIONS

This application claims priority under 35 U.S.C. § 119 to Korean Patent Application Nos. 2005-66946, filed on Jul. 30, 2005, 2005-104791, filed on Nov. 3, 2005, and 2005-104795, filed on Nov. 3, 2005, the contents of which are herein incorporated by reference in their entireties.

### BACKGROUND OF THE INVENTION

1. Field of the Invention

Example embodiments of the present invention relate to a polarization compensation film, a display panel assembly and a display device having the polarization compensation film. More particularly, example embodiments of the present invention relate to a polarization compensation film that is capable of improving light efficiency, a display panel assembly and a display device having the polarization compensation film.

2. Description of the Related Art

Generally, a portable information device such as a mobile communication terminal, a digital camera, an electronic scheduler, etc., includes a display device for displaying an image. Though various types of display devices can be used as the display device, a flat-shaped display device having a small size and a light weight is generally used, as the portable information device also generally has a small size and a light weight. Particularly, a liquid crystal display (LCD) device, which displays an image using liquid crystal, is widely employed. The LCD device has a relatively thin thickness and a light weight, a low driving voltage and low power consumption compared with other display devices.

The LCD device may be classified as either a transmissive LCD device or a reflective LCD device. The transmissive LCD device displays an image using an internal light generated from a backlight unit. The reflective LCD device displays an image using an external light such as sunlight.

The transmissive LCD device employs the internal light generated from within the transmissive LCD device, so that the transmissive LCD device has an advantage of being able to be used in dark indoor environments. On the other hand, the transmissive LCD device needs high power consumption for generating the internal light and disadvantageously has low image quality when used outdoors because of reflection of the external light.

The reflective LCD device does not use the internal light so that the reflective LCD device advantageously has low power consumption and high image quality. On the other hand, disadvantageously, the reflective LCD device may not be able to be used in dark indoor environments.

Accordingly, research is being actively conducted on a transflective LCD device that can display high-quality image information both indoors and outdoors.

The transflective LCD device includes a liquid display panel and a backlight unit. The liquid display panel may display an image using the internal light and the external light. The backlight unit may provide the liquid display panel with the internal light.

The liquid display panel includes a plurality of unit pixels displaying an image. Each unit pixel has a transparent region and a reflective region. The transparent region may display an image using the internal light. The reflective region may display an image using the external light.

Therefore, the transflective LCD device may be operated in a transmission mode or in a reflective mode. In a transmission mode, the internal light may penetrate the transmission region to display an image. In a reflective mode, the external light may be reflected from the reflective region so that an image may be displayed. Thus, the transmission mode may be used in a dark area and the reflective mode may be used in a bright area.

In the meantime, polarizing plates are disposed over and under the liquid display panel. The polarizing plates allow some portions of light that oscillate in a specific direction to pass through the polarizing plates and absorb other portions of the light that oscillate in other directions.

Thus, when the transflective LCD device is used in the reflective mode, some portions of the external light penetrate the polarizing plate and other portions of the external light are absorbed by the polarizing plate. Therefore, light efficiency is decreased so that luminance of the transflective LCD device may be reduced.

### SUMMARY OF THE INVENTION

Example embodiments of the present invention provide a polarization compensation film that is capable of allowing desired polarized light to pass through the polarization compensation film, and changing undesired polarized light into desired polarized light and then allowing the changed polarized light to pass through the polarization compensation film, thereby improving light efficiency.

Example embodiments of the present invention provide a display panel assembly having the above-mentioned polarization compensation film.

Example embodiments of the present invention provide a display device having the above-mentioned display panel assembly.

According to one aspect of the present invention, there is provided a polarization compensation film. The polarization compensation film includes a polarization prism film and a phase difference film. The polarization prism film divides an incident natural light wave into an ordinary wave with a first polarization state, and an extraordinary wave with a second polarization state that progresses in a direction inclined relative to the ordinary wave. The phase difference film changes the second polarization state of the extraordinary wave incident from the polarization prism film into the first polarization state.

In an example embodiment of the present invention, the polarization prism may include a first layer, and a second layer combined with the first layer. The first and second layers have different refractive indexes with each other. An interface between the first layer and the second layer may have a prism shape. The ordinary wave may go straight at the interface, and the extraordinary wave may be refracted from the interface by a predetermined angle with respect to the ordinary wave. The second layer may include a liquid crystal layer having birefringence characteristics. The first layer may include a transparent resin layer.

The phase difference film may include a liquid crystal layer having the birefringence characteristics. Liquid crystals contained in the liquid crystal layer may be positioned inclined to an x-axis on an x-z plane. Here, a z-axis indicates a direction substantially parallel with a progressing direction of the ordinary wave, the x-axis indicates a direction substantially parallel with an oscillating direction of the ordinary wave, and a y-axis indicates a direction substantially perpendicular to the x-z plane. The liquid crystals contained in the liquid crystal layer may be arranged to be continuously changed by an angle of about 0° to about 90° with respect to the z-axis on the x-z plane.

The phase difference film may include at least two liquid crystal layers having the birefringence characteristics. The liquid crystals contained in each liquid crystal layer may be arranged to be continuously changed by an angle of about 0° to about 90° with respect to the z-axis on the x-z plane.

According to another aspect of the present invention, there is provided a method of manufacturing a polarization prism film. The method of manufacturing the polarization prism film includes forming a transparent resin layer that has a prism-shaped upper portion, forming a lower alignment layer on the transparent resin layer, rubbing the lower alignment layer, forming a liquid crystal layer having the birefringence characteristics on the lower alignment layer and hardening the liquid crystal layer.

In an example embodiment of the present invention, forming the transparent resin layer may include preparing a base film and forming a prism layer having a prism shape on the base film. The method of manufacturing the polarization prism film may further include thermally treating the lower alignment layer after forming the lower alignment layer. The lower alignment layer is rubbed along a rubbing direction substantially parallel or perpendicular to a lengthwise direction of the prism-shaped upper portion. The liquid crystal layer is hardened by ultraviolet radiation.

According to another aspect of the present invention, there is provided a display panel assembly. The display panel assembly includes a display panel displaying an image, a first polarizing plate disposed over the display panel, a second polarizing plate disposed under the display panel, and a polarization compensation film disposed over the first polarizing plate. The polarization compensation film includes a polarization prism film and a phase difference film. The polarization prism film divides an incident natural light wave into an ordinary wave with a first polarization state, and an extraordinary wave with a second polarization state to form a predetermined angle with respect to the ordinary wave. The phase difference film changes the second polarization state of the extraordinary wave incident from the polarization prism film into the first polarization state. The display device includes a backlight unit disposed under the second polarizing plate, providing light to the second polarizing plate. The display panel may include a reflective panel or a transflective panel.

According to still another aspect of the present invention, there is provided a display panel assembly. The display device includes a display panel displaying an image, a first polarizing plate disposed over the display panel, a second polarizing plate disposed under the display panel, a polarization compensation film disposed under the second polarizing plate and a backlight unit disposed under the second polarizing plate, providing light to the second polarizing plate. The polarization compensation film includes a polarization prism film and a phase difference film. The polarization prism film divides a natural light wave incident from the backlight assembly into an ordinary wave with a first polarization state corresponding to a light transmissive axis of the second polarizing plate, and an extraordinary wave with a second polarization state progressing to form a predetermined angle with respect to the ordinary wave. The phase difference film changes the second polarization state of the extraordinary wave incident from the polarization prism film into the first polarization state. Here, the display panel may include a transmissive panel.

According to the present invention, a polarization compensation film transmits light with a desired polarization state as it is. The polarization compensation film changes light with an undesired polarization state into light with the desired polarization state, and then transmits the light with the desired polarization state. By using the polarization compensation film, light efficiency may be improved and overall luminance of the display device may be increased.

### BRIEF DESCRIPTION OF THE DRAWINGS

FIG. 1 is a cross-sectional view illustrating a polarization compensation film in accordance with an example embodiment of the present invention.

FIG. 2 is a conceptual view illustrating a function of the polarization compensation film of FIG. 1.

FIG. 3 is a cross-sectional view specifically illustrating a polarization prism film in FIG. 1.

FIG. 4 is a flow chart illustrating a process of manufacturing the polarization prism film in accordance with an example embodiment of the present invention.

FIGS. 5 to 9 are cross-sectional views illustrating the process of manufacturing the polarization prism film, as shown in the flowchart in FIG. 4.

FIG. 10 is a flow chart illustrating a process of manufacturing the polarization prism film in accordance with an example embodiment of the present invention.

FIG. 11 is a cross-sectional view illustrating the process of manufacturing the polarization prism film, as shown in the flow chart in FIG. 10.

FIG. 12 is a perspective view illustrating a phase difference film in FIG. 2.

FIG. 13 is a cross-sectional view illustrating an alignment of liquid crystals on an x-z plane in FIG. 12.

FIG. 14 is a cross-sectional view illustrating a shape of a liquid crystal positioned on the x-z plane in FIG. 12.

FIG. 15 is a cross-sectional view illustrating a shape of a liquid crystal positioned on a y-z plane in FIG. 12.

FIG. 16 is a graph illustrating a transmittance ratio in a case where the pre-tilt angle of liquid crystals is about 60°.

FIG. 17 is a graph illustrating the transmittance ratio in a case where the pre-tilt angle of liquid crystals is about 70°.

FIG. 18 is a cross-sectional view illustrating an arrangement of liquid crystals in the phase difference film in accordance with another example embodiment of the present invention.

FIG. 19 is a graph illustrating a transmittance ratio in a case where the phase difference film in FIG. 18 is used.

FIG. 20 is a cross-sectional view illustrating a phase difference film in accordance with an example embodiment of the present invention.

FIGS. 21 to 22 are cross-sectional views illustrating arrangements of liquid crystals contained in a liquid crystal layer in FIG. 20.

FIG. 23 is a cross-sectional view illustrating a display device in accordance with an example embodiment of the present invention.

FIG. 24 is a plan view specifically illustrating a display panel in FIG. 23.

FIG. 25 is a cross-sectional view taken along a line I-I′ in FIG. 24.

FIG. 26 is a cross-sectional view illustrating a display device in accordance with an example embodiment of the present invention.

FIG. 27 is a conceptual view illustrating light paths when an electric field is not applied to a display panel of a display panel assembly illustrated in FIG. 26.

FIG. 28 is a conceptual view illustrating light paths when an electric field is applied to the display panel of the display panel assembly illustrated in FIG. 26.

FIG. 29 is a cross-sectional view illustrating a display device in accordance with an example embodiment of the present invention.

### DESCRIPTION OF EMBODIMENTS

The present invention is described more fully hereinafter with reference to the accompanying drawings, in which example embodiments of the present invention are shown. The present invention may, however, be embodied in many different forms and should not be construed as limited to the example embodiments set forth herein.

Example embodiments of the present invention are described herein with reference to cross-section illustrations that are schematic illustrations of idealized embodiments (and intermediate structures) of the present invention. Thus, example embodiments of the present invention should not be construed as limited to the particular shapes of regions illustrated herein but may to include deviations in shapes that result, for example, from manufacturing.

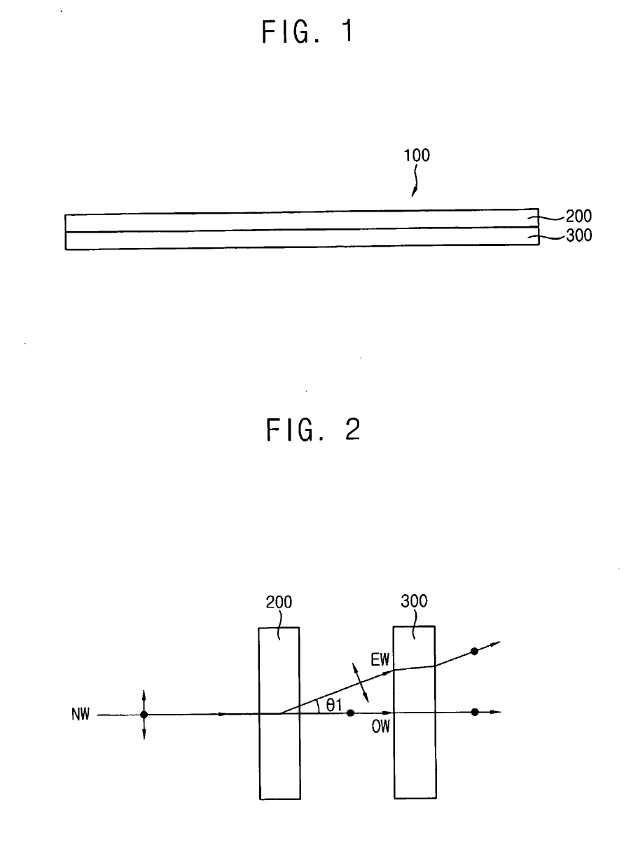

FIG. 1 is a cross-sectional view illustrating a polarization compensation film in accordance with an example embodiment of the present invention. FIG. 2 is a conceptual view illustrating a function of the polarization compensation film in FIG. 1.

Referring to FIGS. 1 and 2, the polarization compensation film 100 in accordance with an example embodiment of the present invention includes a polarization prism film 200 and a phase difference film 300.

The polarization prism film 200 divides a natural light wave NW incident from the exterior into an ordinary wave OW with a first polarization state, and an extraordinary wave EW with a second polarization state that oscillates along a direction substantially perpendicular to an oscillation direction of the ordinary wave OW. Here, after passing through the polarization prism film 200, the ordinary wave OW goes straight, whereas the extraordinary wave EW is refracted by an angle of θ1 with respect to the ordinary wave OW.

The phase difference film 300 is disposed on an emission face of the polarization prism film 200. The phase difference film 300 may be integrally combined with the emission face of the polarization prism film 200 or separated from the emission face of the polarization prism film 200.

The phase difference film 300 emits the ordinary wave OW with the first polarization state incident from the polarization prism film 200 as it is. On the other hand, the phase difference film 300 changes the second polarization state of the extraordinary wave incident from the polarization prism film 200 into the first polarization state, and emits the extraordinary wave with the first polarization state.

Therefore, the natural light wave NW is changed into a wave with the first polarization state by penetrating the polarization compensation film 100. Here, the polarization compensation film 100 changes the extraordinary wave EW with the second polarization state as well as the ordinary wave OW with the first polarization state into the wave with the first polarization state. Thus, a quantity of the wave with the first polarization state transmitted from the polarization compensation film 100 substantially doubly increases.

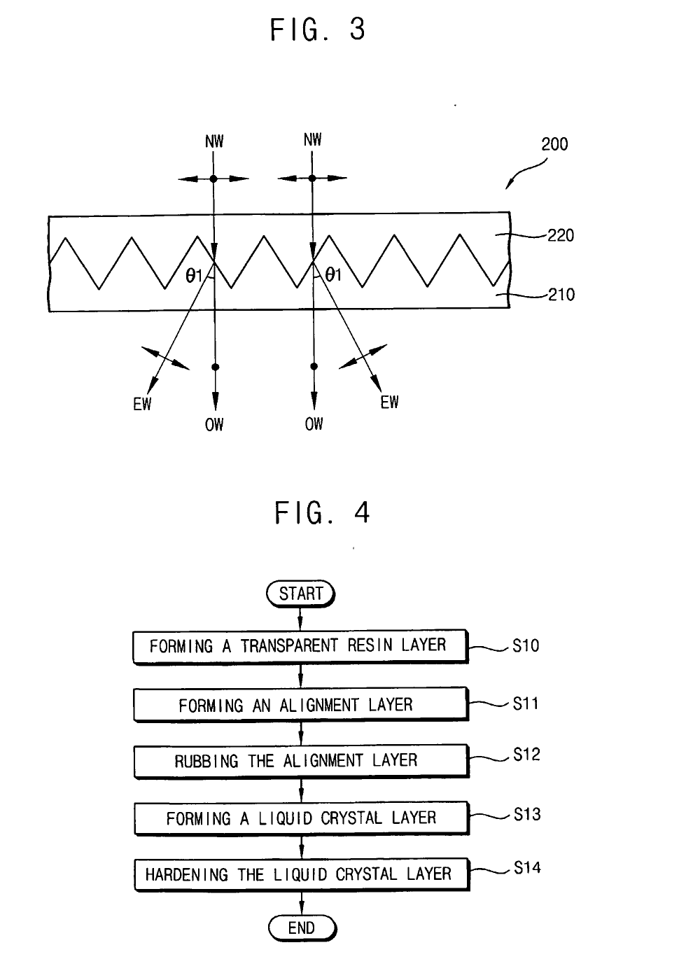

FIG. 3 is a cross-sectional view specifically illustrating the polarization prism film 200 in FIG. 1.

Referring to FIG. 3, the polarization prism film 200 includes a first layer 210 and a second layer 220 combined with the first layer 210. The first and second layers 210 and 220 have different refractive indexes with each other.

The first layer 210 includes a transparent resin layer. For example, the first layer can 210 include polyethylene terephthalate (PET) or polycarbonate (PC). The second layer 220 includes a liquid crystal layer having birefringence characteristics. Liquid crystals contained in the liquid crystal layer have the birefringence characteristics, where a refractive index of a major axis of the liquid crystals is different from that of a minor axis of the liquid crystals. The liquid crystals are arranged along a predetermined direction in the liquid crystal layer.

An interface between the first layer 210 and the second layer 220 has a prism shape. Particularly, the interface between the first layer 210 and the second layer 220 has a continuous triangular pattern on the cross-sectional view of the polarization prism film in FIG. 3.

The natural light wave NW substantially vertically incident on the polarization prism film 200 is divided into the ordinary wave OW with the first polarization state, and the extraordinary wave EW with the second polarization state at the interface. The ordinary wave OW with the first polarization state oscillates along a direction substantially perpendicular to a plane in FIG. 3. The extraordinary wave EW with the second polarization state oscillates along the plane in FIG. 3.

Thus, the ordinary wave OW goes straight at the interface, whereas the extraordinary wave EW is refracted from the interface by an angle of θ1 with respect to the ordinary wave.

Alternatively, by changing an arrangement of the liquid crystals contained in the second layer 220, the natural light wave NW substantially vertically incident on the polarization prism film 200 may be divided into the ordinary wave OW with the second polarization state oscillating in the plane in FIG. 3 and the extraordinary wave EW with the first polarization state oscillating in a direction substantially perpendicular to the plane in FIG. 3.

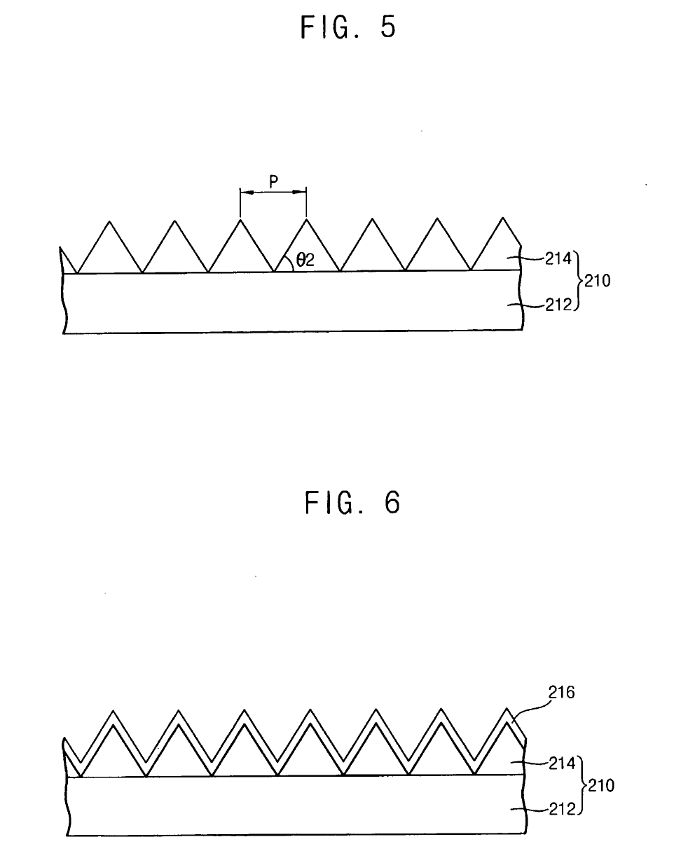

FIG. 4 is a flow chart illustrating a process of manufacturing the polarization prism film in accordance with one example embodiment of the present invention. FIGS. 5 to 9 are cross-sectional views illustrating the process of manufacturing the polarization prism film, as shown in the flowchart in FIG. 4.

Referring to FIGS. 4 and 5, for manufacturing the polarization prism film 200, in step S10, a transparent resin 210, of which an upper portion has a prism shape, is formed. For example, the transparent resin layer 210 is formed by forming a prism layer 214 having the prism shape on a base film 212.

The base film 212 and the prism layer 214 include a transparent material through which light passes. For example, the base film 212 and the prism layer 214 include the material such as PET or PC, having good transmittance and flexibility. The prism layer 214 may be formed from an acryl-based material or a polymer-based material.

A refractive index of the transparent resin layer 210 may be substantially the same as that of the minor axis of the liquid crystal contained in the liquid crystal layer that is to be formed over the transparent resin layer 210.

An angle θ1 between the ordinary wave and the extraordinary wave, which are separated at the interface of the prism layer 214, is determined in accordance with a birefringence index of the liquid crystal, and an inclination angle θ2 of the prism shape formed in the prism layer 214. Thus, the angle θ1 between the ordinary wave and the extraordinary wave becomes wider, as the birefringence index and the inclination angle θ2 become larger.

As the liquid crystal has an inherent birefringence index, to make the angle 01 wider, it is advantageous to make the inclination angle θ2 wider. However, when the inclination angle θ2 comes to be too wide, an interfacial reflection caused by a Fresnel reflection may become large so that the transmittance may be decreased.

Thus, the inclination angle θ2 serves to widen the angle θ1 between the ordinary wave and the extraordinary wave without decreasing the transmittance. For example, when a liquid crystal having a birefringence index of about 0.204 is used, the inclination angle θ2 of the prism shape is in a range of about 60° to about 70°, and the angle θ1 between the ordinary wave and the extraordinary wave is in a range of about 9.8° to about 13.5°.

An interval P between the prism shapes is determined by considering producibility of a device and easy performance of a subsequent process. For example, the interval P between the prism shapes is in a range of about 10 μm to 20 μm.

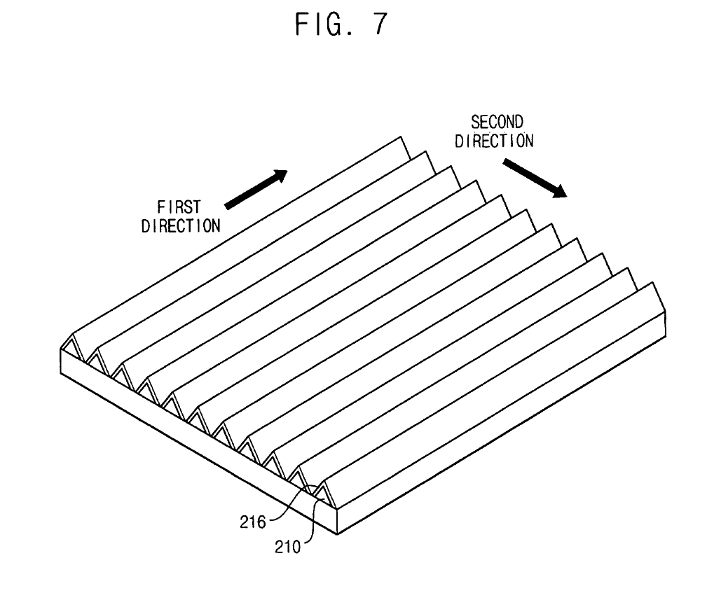

Referring to FIGS. 4 and 6, after the transparent resin layer 210 is formed, an alignment layer 216 is formed on the transparent resin layer 210, in step S11. For example, the lower alignment layer 216 includes polyimide (PI).

After the lower alignment layer 216 is formed, a heat-treatment process of the lower alignment layer 216 may be additionally performed. The heat-treatment process may be performed at a temperature of no more than about 130° C. to prevent deformation of the transparent resin layer 210.

Referring to FIGS. 4 and 7 to 9, after the lower alignment layer 216 is formed on the transparent resin layer 210, the lower alignment layer 216 is rubbed, in step S12.

Sequentially, a liquid crystal layer 220 having the birefringence characteristics is formed on the rubbed lower alignment layer 216, in step S13.

Liquid crystals formed on the lower alignment layer 216 by a rubbing process are arranged so that the major axis of the liquid crystals is substantially parallel with a rubbing direction of the lower alignment layer 216.

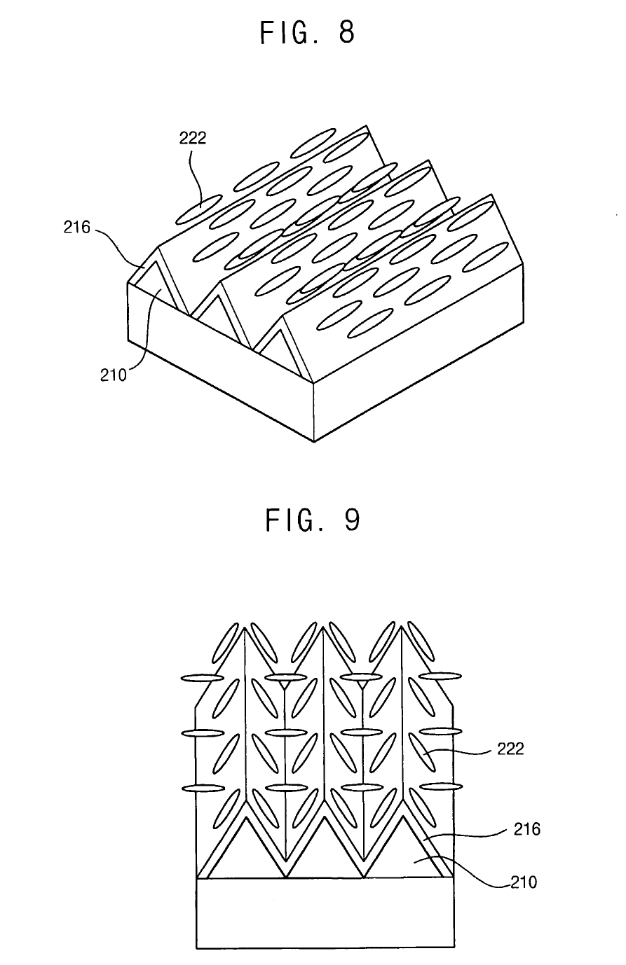

As illustrated in FIG. 7, in accordance with one example embodiment of the present invention, the rubbing process is performed in a first direction substantially parallel with a lengthwise direction of the prism-shaped upper portion. When the rubbing process is performed in the first direction substantially parallel with the lengthwise direction of the prism-shaped upper portion, the long axes of liquid crystals 222 are arranged in a direction substantially parallel with the lengthwise direction of the prism-shaped upper portion illustrated in FIG. 8.

When the liquid crystals 222 are arranged as illustrated in FIG. 8, a Rochon polarization prism film is formed. As illustrated in FIG. 3, the Rochon polarization prism film divides the natural light wave NW substantially vertically incident on the liquid crystal layer 220 into the ordinary wave OW with the first polarization state, and the extraordinary wave EW with the second polarization state. The ordinary wave OW with the first polarization state oscillates in a direction perpendicular to the plane in FIG. 3. The extraordinary wave EW with the second polarization state oscillates on the plane in FIG. 3.

In accordance with another example embodiment of the present invention, as illustrated in FIG. 7, the rubbing process may be performed in a second direction substantially perpendicular to the lengthwise direction of the prism-shaped upper portion. When the rubbing process is performed in the second direction substantially perpendicular to the lengthwise direction of the prism-shaped upper portion, the long axes of the liquid crystals 222 are arranged in a direction substantially perpendicular to the lengthwise direction of the prism-shaped upper portion illustrated in FIG. 9.

When the liquid crystals 222 are arranged as illustrated in FIG. 9, a Senarmont polarization film is formed. The Senarmont polarization prism film divides the natural light wave NW substantially vertically incident on the liquid crystal layer 220 into the ordinary wave OW with the second polarization state, and the extraordinary wave EW with the first polarization state. The ordinary wave OW with the second polarization state oscillates on the plane in FIG. 3. The extraordinary wave EW with the first polarization state oscillates in a direction perpendicular to the plane in FIG. 3.

After the liquid crystal layer 220 is formed, the liquid crystal layer 220 is hardened, in step S14 by ultraviolet radiation. Thus, an ultraviolet ray having a wavelength of about 365 nm is irradiated into the liquid crystal layer 220 under a nitrogen atmosphere, to harden the liquid crystal layer 220 by a photopolymerization reaction. An arrangement of the liquid crystals 222 contained in the liquid crystal layer 220 is fixed by the hardening process.

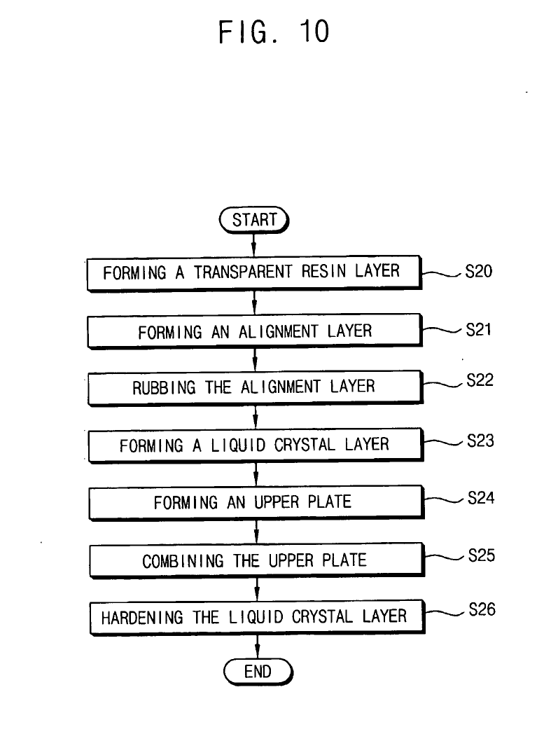

FIG. 10 is a flow chart illustrating a process of manufacturing a polarization prism film in accordance with another example embodiment of the present invention.

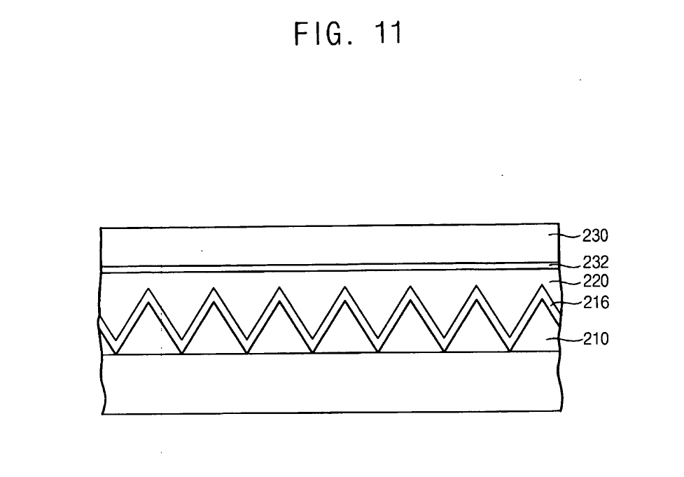

FIG. 11 is a cross-sectional view illustrating a process of manufacturing the polarization prism film as shown in the flow chart in FIG. 10.

Referring to FIGS. 10 and 11, the process of manufacturing the polarization prism film in accordance with another example embodiment of the present invention includes a process of forming a transparent resin layer 210, in step S20, a process of forming a lower alignment layer 216 on the transparent resin layer 210, in step S21, a process of rubbing the lower alignment layer 216, in step S22, a process of forming a liquid crystal layer 220 on the lower alignment layer 216, in step S23, a process of forming an upper plate 230 rubbed along a direction that is substantially the same as a rubbing direction of the lower alignment layer 216, in step S24, a process of combining the upper plate 230 with the transparent resin layer 210, the liquid crystal layer 220 being disposed between an upper plate 230 and the transparent resin layer 210, in step S25, and a process of hardening the liquid crystal layer 220, in step S26.

The processes from forming the transparent resin layer 210, in step S20 to forming the liquid crystal layer 220, in step S23 are substantially the same as those described from step S10 to step S13 in FIG. 4.

In a process of forming the upper plate 230, after an upper alignment layer 232 is formed on any one face of the upper plate 230, the upper alignment layer 232 is rubbed along a predetermined direction so that the rubbed upper plate 230 is completed.

After the rubbed upper plate 230 is completed, the rubbed upper plate 230 is disposed over the liquid crystal layer 220, so that a rubbed face of the upper plate 230 faces the liquid crystal layer 220. Here, the rubbed upper plate 230 is disposed over the liquid crystal layer 220 so that a rubbing direction of the upper alignment layer 232 formed on the upper plate 230 is matched to that of the lower alignment layer 216 formed on the transparent resin layer 210.

After the upper plate 230 is combined with the liquid crystal layer 220, the liquid crystal layer 220 is hardened in step S26. The process of hardening the liquid crystal layer 220 is substantially the same as that described in step S15 in FIG. 4.

Accordingly, when the liquid crystals contained in the liquid crystal layer 220 are simultaneously arranged through both the lower alignment layer 216 formed on the transparent resin layer 210 and the upper alignment layer 232 formed on the upper layer 230, a capacity of aligning the liquid crystals is further improved compared with a case in which the lower alignment layer 216 is only formed on the transparent resin layer 210.

In the meantime, after the alignment of the liquid crystals is completed by hardening the liquid crystal layer 220, the upper plate 230 may be removed.

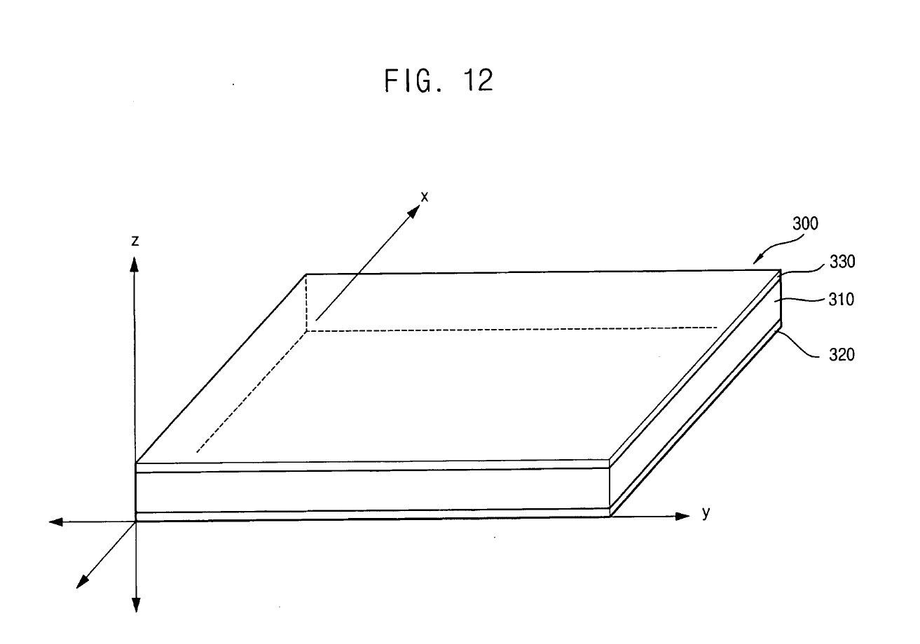

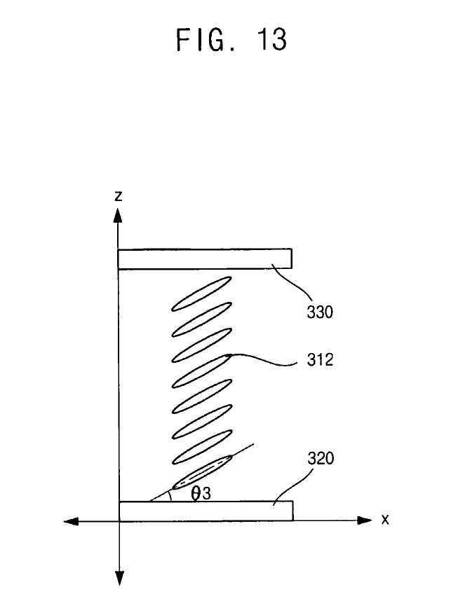

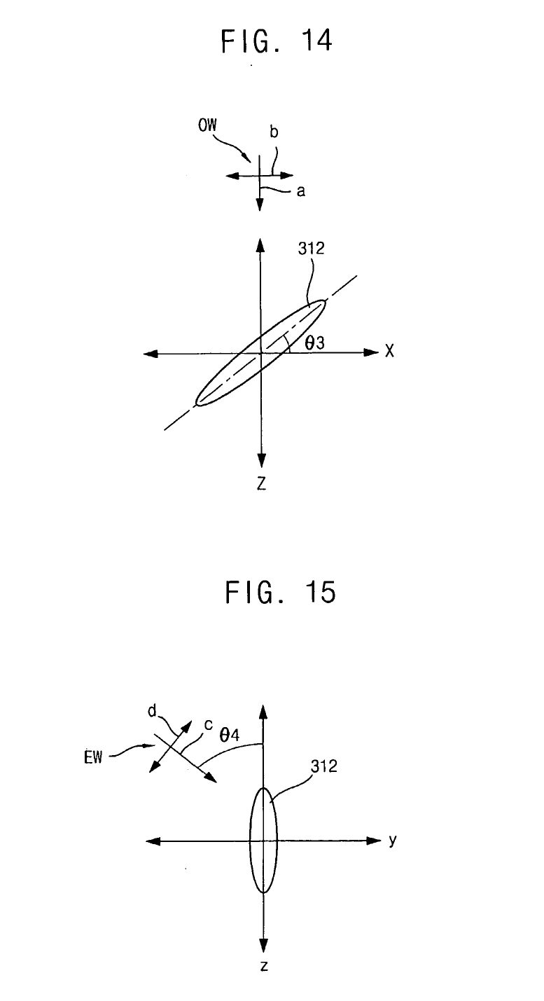

FIG. 12 is a perspective view illustrating the phase difference film 300 in FIG. 2, and FIG. 13 is a cross-sectional view illustrating an alignment of liquid crystals on an x-z plane in FIG. 12.

Referring to FIGS. 12 and 13, the phase difference film 300 includes a liquid crystal layer 310 where liquid crystals 312 having birefringence characteristics are uniformly arranged. For example, the liquid crystal layer 310 is protected by a lower support plate 320 disposed in a lower portion of the phase difference film 300 and an upper support plate 330 disposed in an upper portion of the phase difference film 300.

In accordance with one example embodiment of the present invention, the liquid crystals 312 contained in the liquid crystal layer 310 have the birefringence characteristics, where a refractive index of the major axis is different from that of the minor axis. The liquid crystals 312 are arranged in a predetermined direction in the liquid crystal layer 310.

The liquid crystals 312 contained in the liquid crystal layer 310 are positioned to form a predetermined angle θ3 with respect to an x-axis on the x-z plane. Here, a z-axis indicates a direction substantially parallel with a progressing direction of the ordinary wave OW incident from the polarization prism film 200, the x-axis indicates a direction substantially parallel with an oscillating direction of the ordinary wave OW with the first polarization state, and a y-axis indicates a direction substantially perpendicular to the x-z plane.

The x-axis indicates a direction parallel with the lengthwise direction of the prism-shaped upper portion in the polarization prism film 200. Thus, the liquid crystals 312 are arranged to form a pre-tilt angle by a predetermined angle θ3, with respect to the x-axis along the lengthwise direction of the prism-shaped upper portion in the polarization prism film 200. For example, a pre-tilt angle θ3 between the liquid crystals and the x-axis is in a range of about 60° to about 70°.

FIG. 14 is a cross-sectional view illustrating a shape of a liquid crystal positioned on the x-z plane and FIG. 15 is a cross-sectional view illustrating a shape of a liquid crystal positioned on a y-z plane.

Referring to FIGS. 12 and 14, the liquid crystals 312 are positioned so that the major axis of the liquid crystals 312 forms a predetermined angle θ3 with respect to the x-axis on the x-z plane.

After passing through the polarization prism film 200, the ordinary wave OW is incident on the phase difference film 300, and has a progressing direction substantially parallel with the z-axis. Here, because the ordinary wave OW has the first polarization state that oscillates on the x-z plane, the ordinary wave OW does not experience phase retardation when passing through the liquid crystals 312, so that the ordinary wave OW passes through the phase difference film 300 with the first polarization state.

Referring to FIGS. 12 and 15, the liquid crystal 312 is positioned along a direction substantially parallel with the z-axis on the y-z plane.

After passing through the polarization prism film 200, the extraordinary wave EW is incident on the phase difference film 300, having a progressing direction to form a predetermined angle θ4 with respect to the z-axis. Here, because the extraordinary wave has the second polarization state that oscillates on the y-z plane, the extraordinary wave EW experiences the phase difference when passing through the liquid crystals 312 so that the polarization state of the extraordinary wave EW is changed into the first polarization state through the birefringence characteristics of the liquid crystals 310.

A phase shift in the extraordinary wave EW caused by the phase difference film 300 is determined in accordance with a birefringence of the liquid crystals 312 and a thickness of the liquid crystal layer 310. Here, the birefringence of the liquid crystals 312 is an inherent value according to types of the liquid crystals. Thus, by controlling the thickness of the liquid crystal layer 310 in order that a phase difference is 180°, the second polarization state of the extraordinary wave is changed into the first polarization state.

Accordingly, the phase difference film 300 emits the ordinary wave with the first polarization state separated by the polarization prism film 200 as the first polarization state, and changes the extraordinary wave with the second polarization state into that with the first polarization state, and emits the extraordinary wave as the first polarization state. Thus, a quantity of a wave with the first polarization state emitted through the polarization compensation film 100 substantially doubly increases. By matching a polarization direction of the first polarization state to a transmission axis of a polarizing plate attached to a liquid crystal display (LCD) panel, light efficiency may be improved.

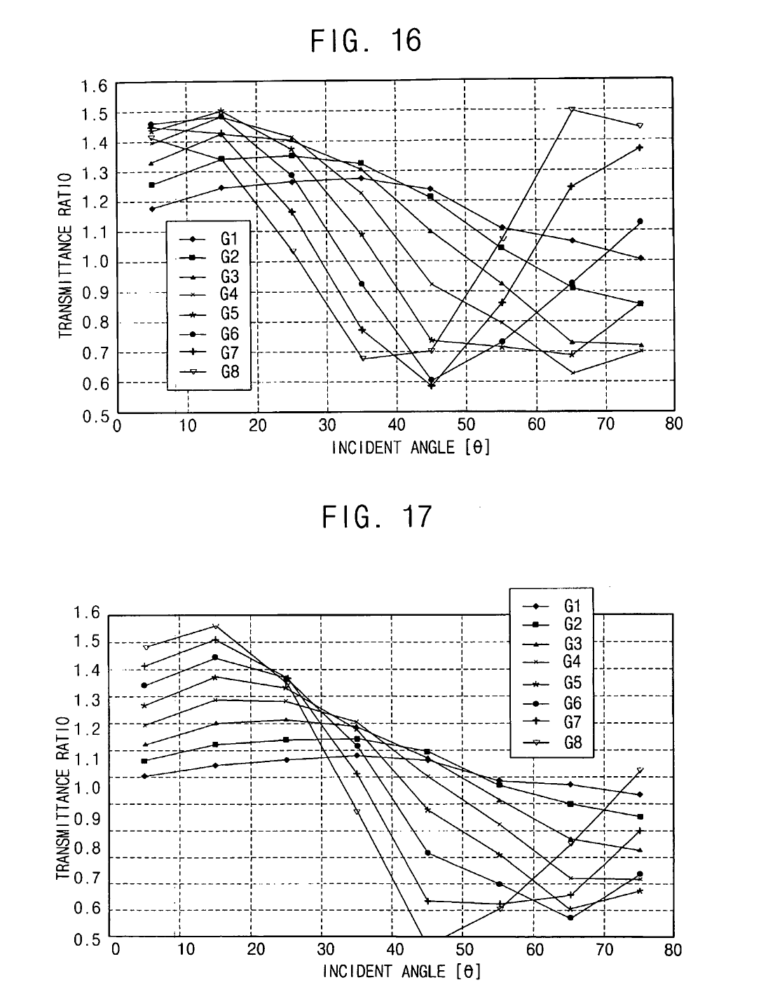

FIG. 16 is a graph illustrating a transmittance ratio in a case where the pre-tilt angle of liquid crystals is about 60°, and FIG. 17 is a graph illustrating a transmittance ratio in a case where the pre-tilt angle of liquid crystals is about 70°. In FIGS. 16 and 17, an x-axis of the graph indicates an incident angle of the natural light wave incident on the polarization compensation film and a y-axis indicates a transmittance of light after passing through the polarizing plate attached to a lower portion of the polarization compensation film. In FIGS. 16 and 17, G1 is a thickness of about 2 μm as a liquid crystal layer, G2 is a thickness of about 2.5 μm, G3 is a thickness of about 3 μm, G4 is a thickness of about 3.5 μm, G5 is a thickness of about 4 μm, G6 is a thickness of about 4.5 μm, G7 is a thickness of about 5 μm, and G8 is a thickness of about 5.5 μm. In FIGS. 16 and 17, a transmittance ratio is illustrated as a ratio of the transmittance with the polarization compensation film with respect to that without the polarization compensation film. For example, when only the polarizing plate is used without the polarization compensation film, the transmittance ratio is 1.

Referring to FIGS. 16 and 17, when the pre-tilt angle θ3 of the liquid crystals 312 is about 70° rather than about 60°, the transmittance ratio is higher.

When the incident angle of the natural light wave is in a range of about 0° to about 40°, the transmittance ratio is improved. On the other hand, when the incident angle of the natural light wave is over about 40°, the transmittance ratio is decreased.

For example, when the transmittance ratio was 1.5 at any specific incident angle in FIGS. 16 and 17, the transmittance was about 43% when only the polarizing plate was used, and the transmittance was over about 60% when the polarization compensation film was used with the polarizing plate. Thus, the transmittance was improved by about 50%.

Accordingly, when the pre-tilt angle θ3 of the liquid crystals 312 is about 700 and the thickness of the liquid crystal layer 310 is in a range of about 4 μm to about 4.5 μm, the phase difference film 300 has the most effective transmittance.

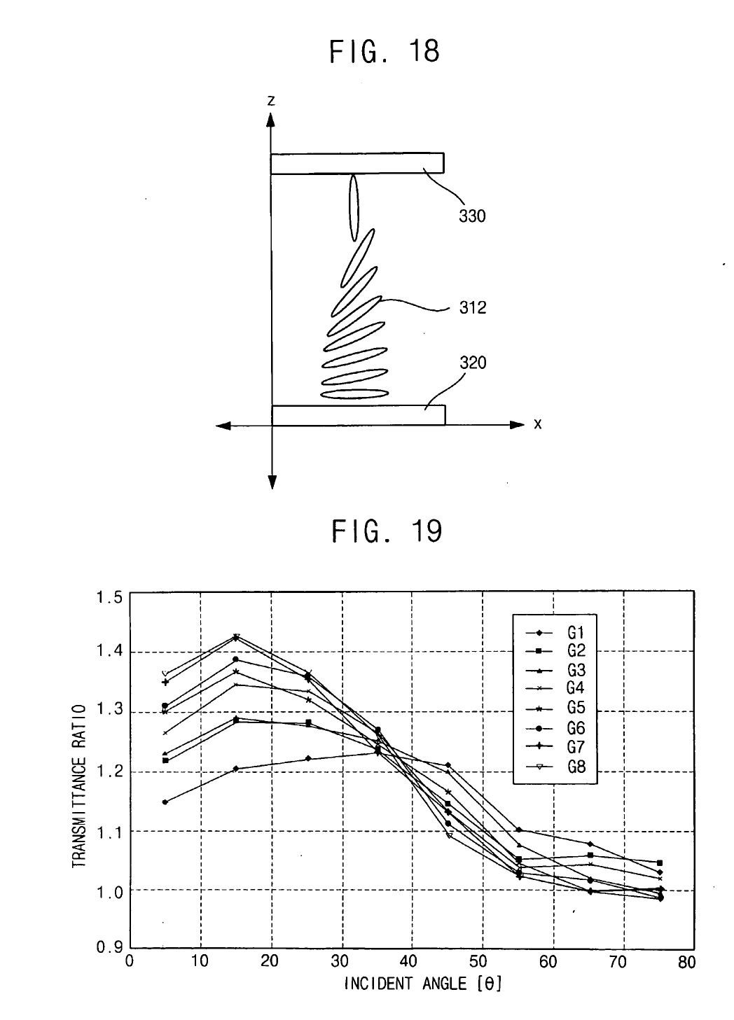

FIG. 18 is a cross-sectional view illustrating an arrangement of liquid crystals in the phase difference film in accordance with another example embodiment of the present invention.

Referring to FIGS. 12 and 18, a phase difference film 300 includes a liquid crystal layer 310. In the liquid crystal layer 310, liquid crystals 312 having the birefringence characteristics are arranged along a predetermined direction. For example, the liquid crystals 310 are protected by a lower plate 320 and an upper plate 330 disposed at a lower portion and at an upper portion of the phase difference film 300, respectively.

The liquid crystals 312 contained in the liquid crystal layer 310 have the birefringence characteristics, where the refractive index of the major axis of the liquid crystals 312 is different from the refractive index of the minor axis of the liquid crystals 312, and the liquid crystals 312 are arranged along a predetermined direction in the liquid crystal layer 310.

The liquid crystals 312 contained in the liquid crystal layer 310 are disposed to be continuously changed by an angle of about 0° to about 90° with respect to the z-axis on the x-z plane of an x-y-z coordination system. Here, the z-axis indicates a direction substantially parallel with a progressing direction of the ordinary wave OW incident from the polarization prism film 200, the x-axis indicates a direction substantially parallel with an oscillating direction of the ordinary wave OW with the first polarization state, and the y-axis indicates a direction substantially perpendicular to the x-z plane.

The x-axis indicates a direction substantially parallel with a lengthwise direction of the prism-shaped upper portion in the polarization prism film 200. Thus, the liquid crystals 312 are arranged along the lengthwise direction of the prism-shaped upper portion in the polarization prism film 200.

FIG. 19 is a graph illustrating a transmittance ratio in a case where the phase difference film in FIG. 18 is used. In FIG. 19, the x-axis of the graph indicates an incident angle of the natural light wave incident on the polarization compensation film and the y-axis indicates the transmittance ratio of light after passing through the polarizing plate attached to the lower portion of the polarization compensation film. In FIG. 19, G1 is a thickness of about 6 μm as the liquid crystal layer, G2 is a thickness of about 8 μm, G3 is a thickness of about 10 μm, G4 is a thickness of about 12 μm, G5 is a thickness of about 14 μm, G6 is a thickness of about 16 μm, G7 is a thickness of about 18 μm and G8 is a thickness of about 20 μm. In FIG. 19, the transmittance ratio is illustrated as a ratio of a transmittance with the polarization compensation film with respect to that without the polarization compensation film. For example, when only the polarizing plate is used without the polarization compensation film, the transmittance ratio is 1.

Referring to FIG. 19, a transmittance ratio of a hybrid-type phase difference film illustrated in FIG. 18 is somewhat lower than that of a pre-tilt-type phase difference film illustrated in FIG. 13.

However, the hybrid-type phase difference film has a relatively low variation in transmittance ratio according to a thickness of the liquid crystal layer 310 compared with that of the pre-tilt-type phase difference film. The hybrid-type phase difference film has a transmittance ratio of over 1 throughout the entire range of incident angles so that the hybrid-type phase difference film better serves to improve the transmittance ratio.

Manufacturing the hybrid-type phase difference film is easier than manufacturing the pre-tilt-type phase difference film.

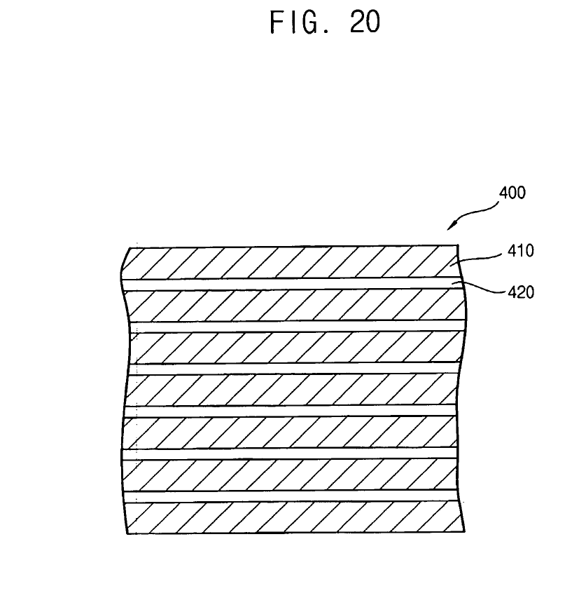

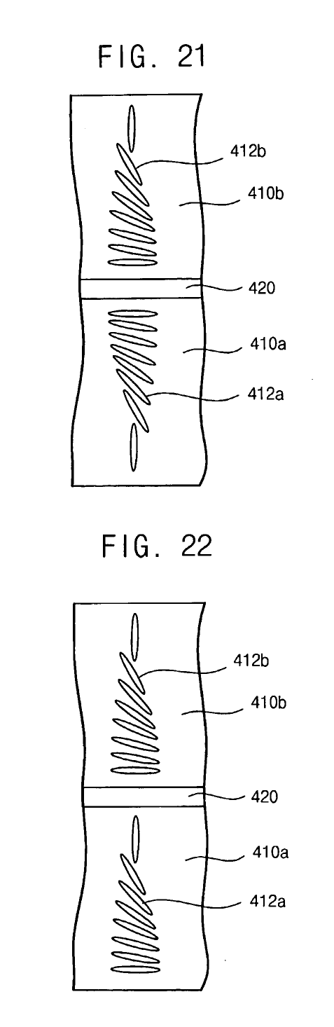

FIG. 20 is a cross-sectional view illustrating a phase difference film in accordance with another example embodiment of the present invention. FIGS. 21 and 22 are cross-sectional views illustrating arrangements of liquid crystals contained in a liquid crystal layer shown in FIG. 20.

Referring to FIGS. 20 to 22, a phase difference film 400 includes at least two liquid crystal layers 410 having the birefringence characteristics.

The liquid crystals contained in the liquid crystal layer 410 have the birefringence characteristics, where a refractive index of the major axis direction of the liquid crystal is different from that of the minor axis direction of the liquid crystal, and the liquid crystals are arranged along a predetermined direction in the liquid crystal layer 410.

Adhesion layers 420 are formed between the liquid crystal layers 410 to combine the liquid crystal layers 410. The adhesion layer 420 is formed from transparent material to transmit light.

The liquid crystals 412 contained in each liquid crystal layer 410 are positioned to be continuously changed by an angle of about 0° to about 90° with respect to the z-axis on the x-z plane of the x-y-z coordination system. Here, the z-axis indicates a direction substantially parallel with a progressing direction of the ordinary wave OW incident from the polarization prism film 200, the x-axis indicates a direction substantially parallel with an oscillating direction of the ordinary wave OW with the first polarization state, and the y-axis indicates a direction substantially perpendicular to the x-z plane.

The x-axis indicates a direction substantially parallel with the lengthwise direction of the prism-shaped upper portion in the polarization prism film 200. Thus, the liquid crystals 412 are arranged along the lengthwise direction of the prism-shaped upper portion in the polarization prism film 200.

As illustrated in FIG. 21, the liquid crystals 412 contained in each liquid crystal layer 410 are symmetrically arranged between adjacent liquid crystal layers 410. Thus, in the phase difference film 400, liquid crystals 412a positioned in a liquid crystal layer 410a and liquid crystals 412b positioned in a liquid crystal layer 410b are continuously arranged based on the adhesion layer 420.

Alternatively, as illustrated in FIG. 22, the liquid crystals 412 contained in each liquid crystal layer 410 may be substantially identically arranged in all liquid crystal layers 410. Thus, in the phase difference film 400, liquid crystals 412a positioned in a liquid crystal layer 410a and liquid crystals 412b positioned in a liquid crystal layer 410b may be discontinuously arranged based on the adhesion layer 420.

Accordingly, a phase difference film 400 manufactured by stacking a plurality of thin liquid crystal layers 410 has substantially the same optical properties as those of a phase difference film 400 manufactured using a single thick liquid crystal layer 410, and manufacturing the phase difference film 400 by stacking a plurality of thin liquid crystal layers 410 may be more easily performed than manufacturing the phase difference film 400 using a single thick liquid crystal layer 410.

The phase difference film 400 manufactured by stacking a plurality of the liquid crystal layers 410 has different transmittance characteristics according to the number of the stacked liquid crystal layers 410 and a thickness of the liquid crystal layers 410.

It may be more efficient for improving a transmittance to stack a small number of relatively thick liquid crystal layers410 rather than to stack a large number of relatively thin liquid crystal layers 410. For example, stacking 2 layers of liquid crystal layer 410 having a thickness of 4 μm is more efficient than stacking 8 layers of liquid crystal layer 410 having a thickness of 1 μm.

It is more efficient for improving a transmittance to have the continuous arrangement of the liquid crystals 412 contained in the stacked liquid crystal layer 410 illustrated in FIG. 21, rather than to have the discontinuous arrangement of the liquid crystals 412 illustrated in FIG. 22.

Thus, when 2 or 3 layers of liquid crystal layer 410 are stacked and the liquid crystals 412 are continuously arranged in the liquid crystal layer 410, the phase difference film 400 has a most improved transmittance.

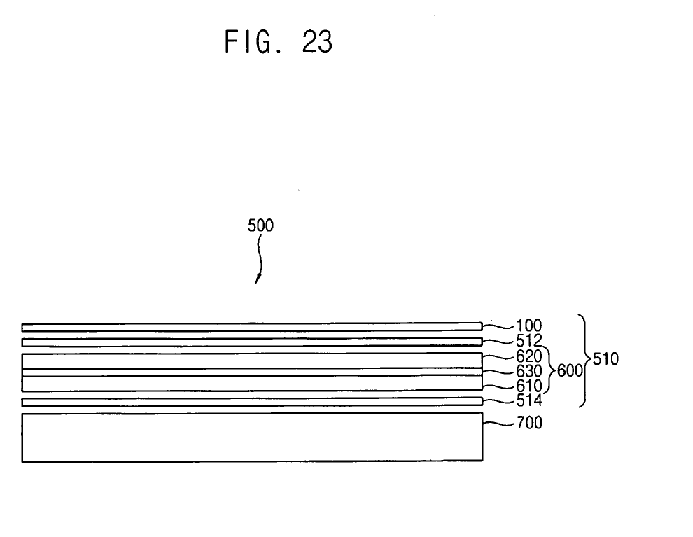

FIG. 23 is a cross-sectional view illustrating a display device in accordance with another example embodiment of the present invention.

Referring to FIG. 23, a display device 500 in accordance with an example embodiment of the present invention includes a display panel assembly 510 and a backlight unit 700.

The display panel assembly 510 includes a display panel 600 displaying an image, a first polarizing plate 512 disposed over the display panel 600, a second polarizing plate 514 disposed under the display panel 600 and a polarization compensation film 100 disposed over the first polarizing plate 512.

In the present example embodiment, the polarization compensation film 100 has a structure that is substantially the same as that of any one of the example embodiments described with reference to FIGS. 1 to 22.

The display panel 600 may be formed as a reflective panel or a transflective panel, displaying an image using external natural light. In the present example embodiment, the transflective panel is hereinafter described as a non-limiting example.

The display panel 600 includes a lower substrate 610, an upper substrate 620 combined to face the lower substrate 610 and a liquid crystal layer 630 disposed between the lower substrate 610 and the upper substrate 620.

The lower substrate 610 includes a reflective region RR reflecting light incident from the first polarizing plate 512 and a transmission region TR transmitting light incident from the second polarizing plate 514. Thus, the display panel 600 displays an image using an external light and an internal light. The external light is provided through the polarization compensation film 100 and the first polarization film 512. The internal light is provided through the second polarizing plate 514 from the backlight unit 700.

The first polarizing plate 512 and the second polarizing plate 514 disposed over and under the display panel 600 respectively, transmit light oscillating in one specific direction and absorb light oscillating in the other directions. For example, the first polarizing plate 512 and the second polarizing plate 514 are disposed so that light transmission axes are perpendicular to each other.

In the present example embodiment, the first polarizing plate 512 is disposed to have the light transmission axis corresponding to a first polarization state of light incident from the polarization compensation film 100. As illustrated in FIGS. 1 to 22, the external light provided from an upper side of the polarization compensation film 100 divides into the ordinary wave with the first polarization state, and the extraordinary wave with the second polarization state when the external light passes through the polarization compensation film 100. Sequentially, the extraordinary wave with the second polarization state is changed into the extraordinary wave with the first polarization state.

Thus, both the ordinary wave and the extraordinary wave, emitted from the polarization compensation film 100, have the first polarization state. By matching a progressing direction of the first polarization to the light transmission axis, light efficiency is improved and overall luminance of the display device is increased.

The backlight unit 700 is disposed under the second polarizing plate 514 and provides light to the display panel assembly 510. The light provided from the backlight unit 700 penetrates the display panel 600 through the transmission region TR of the lower substrate 610, and has an effect on displaying an image.

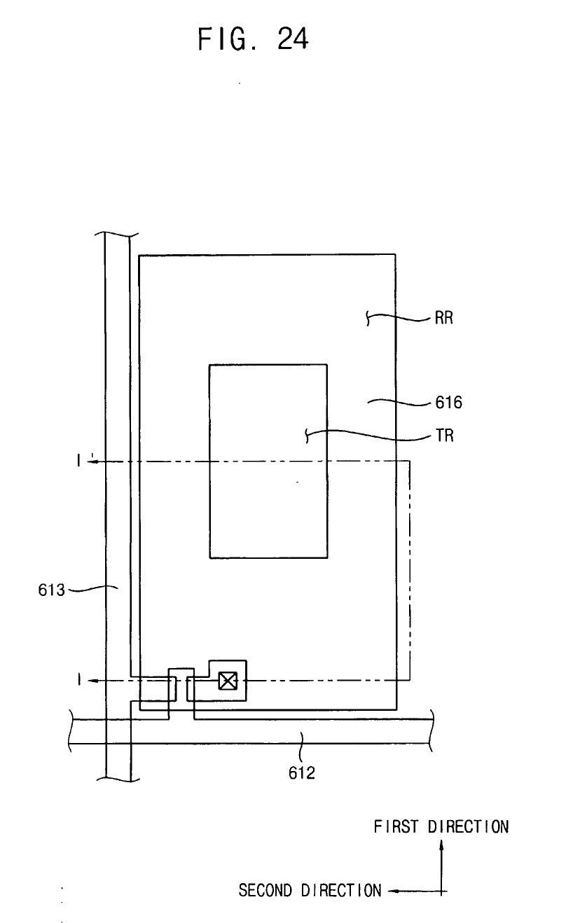

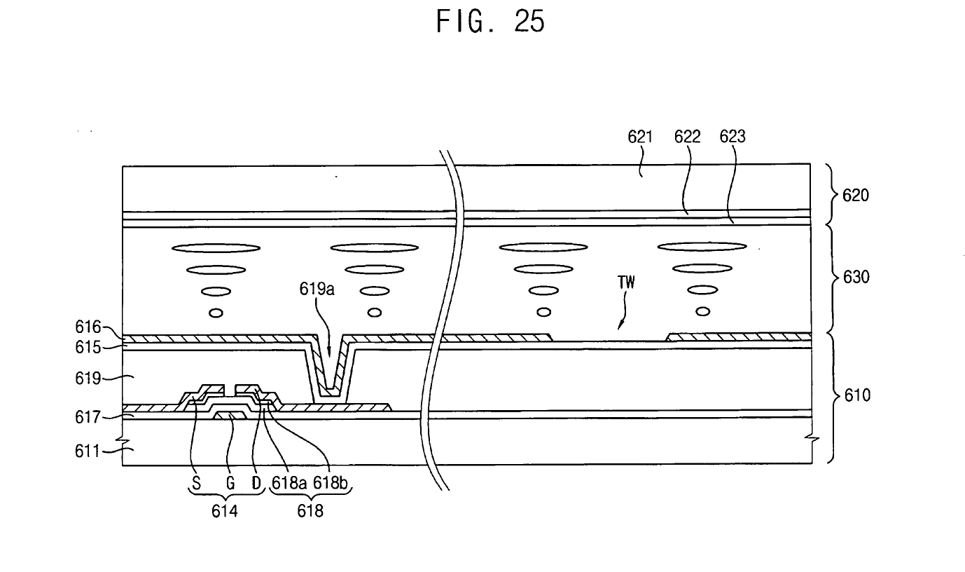

FIG. 24 is a plan view specifically illustrating the display panel in FIG. 23. FIG. 25 is a cross-sectional view taken along the line I-l′ in FIG. 25.

Referring to FIGS. 24 and 25, the display panel 600 includes a lower substrate 610, an upper substrate 620 combined to face the lower substrate 610 and a liquid crystal layer 630 disposed between the lower substrate 610 and the upper substrate 620.

The lower substrate 610 includes the reflective region RR reflecting light incident from an upper side of the lower substrate 610 and the transmission region TR transmitting light incident from a lower side of the lower substrate 610.

The lower substrate 610 includes a transparent substrate 611, a gate line 612, a data line 613, a switching device 614, a transparent electrode 615 and a reflective electrode 616.

The transparent substrate 611 includes a transparent material to transmit light. For example, the transparent substrate 611 includes glass.

The gate line 612 is formed on the transparent substrate 611. The gate line 612 is formed to extend along a second direction.

A gate insulation layer 617 is formed on the transparent substrate 611 having the gate line 612. For example, the gate insulation layer 617 includes a silicon nitride layer or a silicon oxide layer.

An active layer 618 is formed on the gate insulation layer 617 for manufacturing the switching device 614. The active layer 618 includes a semiconductor layer 618a and an ohmic contact layer 618b. The semiconductor layer 618a includes amorphous silicon and the ohmic contact layer 618b includes amorphous silicon highly doped with n-type impurities.

The data line 613 is formed on the gate insulation layer 617. The data line 613 is formed along a first direction to cross the gate line 612.

The switching device 614 is connected to the gate line 612 and the data line 613. A gate terminal G of the switching device 614 is connected to the gate line 612 and a source terminal S of the switching device 614 is connected to the data line 613. Adrain terminal D of the switching device 614 is connected to the transparent electrode 615 and the reflective electrode 616.

An organic layer 619 is formed on the gate insulation layer 617 where the data line 613 and the switching device 614 are formed. A contact hole 619a is formed through the organic layer 619 so that the drain terminal D is electrically connected to the transparent electrode 615 and the reflective electrode 616.

The transparent electrode 615 is formed in a pixel region defined by the gate line 612 and the data line 613. The transparent electrode 615 is connected to the drain terminal D of the switching device 614 through the contact hole 619a formed through the organic layer 619.

The transparent electrode 615 includes a transparent material to transmit light. For example, the transparent electrode 615 includes indium zinc oxide (IZO) or indium tin oxide (ITO).

The reflective electrode 616 is formed on the transparent electrode 615, and forms the reflective region RR. A transmission window TW exposing the transparent electrode 615 is formed in the reflective electrode 616 to form the transmission region TR.

The reflective electrode 616 includes a conductive material having a high reflectivity to reflect light. For example, the reflective electrode 616 includes a single reflective layer or a double reflective layer. The single reflective layer includes an aluminum-neodymium (AlNd) layer. The double reflective layer includes an aluminum-neodymium (AlNd) layer and a molybdenum-tungsten (MoW) layer.

The transmission window TW of the reflective electrode 616 provides the transmission region TR. The transmission region TR allows light supplied from the backlight unit 700 disposed under the display panel 600 to pass through the display panel 600. In the meantime, the reflective electrode 616 provides the reflective region RR to reflect an external light supplied from an upper side of the display panel 600.

The upper substrate 620 includes a transparent substrate 621, a colorfilter layer 622 and a common electrode 623.

The transparent substrate 621 includes a transparent material to transmit light. For example, the transparent substrate 621 includes glass.

The color filter layer 622 is formed on a confronting face of the transparent substrate 621 facing the lower substrate 610. The color filter layer 622 includes red, green and blue colored pixels to produce color. Alternatively, the color filter layer 622 may be formed on the lower substrate 610.

The common electrode 623 is formed on the color filter layer 622 to face the transparent electrode 615 and the reflective electrode 616 of the lower substrate 610. The common electrode 623 includes a transparent conductive material to transmit light. For example, the common electrode 623 includes indium zinc oxide (IZO) or indium tin oxide (ITO).

The liquid crystal layer 630 has a structure in which liquid crystals having optical and electrical properties, such as an anisotropic refractive index, an anisotropic permittivity, etc., are arranged in a predetermined direction. Alignments of the liquid crystals contained in the liquid crystal layer 630 are changed by an electric field formed between the common electrode 623 and the transparent electrode 615 or between the common electrode 623 and the reflective electrode 616. A transmittance of light passing through the liquid crystal layer 630 is controlled in accordance with a change of the alignment of the liquid crystals.

In the display panel 600, when a gate signal is applied to the gate terminal G through the gate line 612, the switching device 614 turns on. According as the switching device 614 turns on, a data signal received through the data line 613 is applied to the transparent electrode 615 and the reflective electrode 616 through the source terminal G and the drain terminal D. The common voltage is applied to the common electrode 623 of the upper substrate 620.

Accordingly, an electric field corresponding to the potential difference between the data signal and the common voltage is formed between the transparent electrode 615 and the common electrode 623 or between the reflective electrode 615 and the common electrode. In accordance with an arrangement change of the liquid crystals caused by the electric field, the transmittance of light provided from an upper side or a lower side of the display panel is changed so that an image having any desired gray scale is displayed.

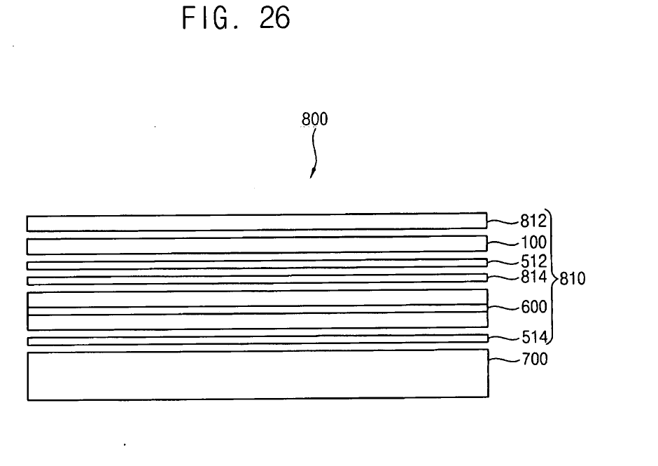

FIG. 26 is a cross-sectional view illustrating a display device in accordance with another example embodiment of the present invention. In FIG. 26, elements excluding a light-control film 812 and a λ/4 film 814 are substantially the same as those described with reference to FIG. 2.

Referring to FIG. 26, the display device 800 includes a display panel assembly 810 and a backlight assembly 700.

The display panel assembly 810 includes a display panel 600, a first polarizing plate 512 disposed over the display panel 600, a second polarizing plate 514 disposed under the display panel 600 and a polarization compensation film 100 disposed over the first polarizing plate 512. The display panel assembly 810 further includes a light-control film 812 disposed over the polarization compensation film 100.

The light-control film 812 changes a light path of a natural light wave incident from any direction into a direction substantially perpendicular to the polarization compensation film 100.

Generally, the natural light wave may be incident on the display panel assembly 810 from any direction. When an incident angle of the natural light wave incident on the polarization compensation film 100 is changed, the ordinary wave divided from the natural light wave through the polarization compensation film is not affected, whereas the extraordinary wave divided from the natural light wave through the polarization compensation film is affected according to the incident angle of the natural light wave. Thus, when the light-control film 812 is disposed over the polarization compensation film 100, the natural light wave, after penetrating the light-control film 812, is substantially perpendicularly incident on the polarization compensation film 100.

Accordingly, by allowing the natural light wave to be substantially perpendicularly incident on the polarization compensation film, a polarization compensation efficiency of the polarization compensation film 100 may be improved.

The display panel assembly 810 may further include the λ/4 film 814 disposed between the display panel 600 and the first polarizing plate 512.

The λ/4 film 814 changes a circular polarization of an incident light wave into a linear polarization, and a linear polarization of an incident light wave into a circular polarization, so that the λ/4 film 814 emits light with a changed polarization state.

Hereinafter, light paths in the display panel assembly in accordance with an example embodiment of the present invention is described.

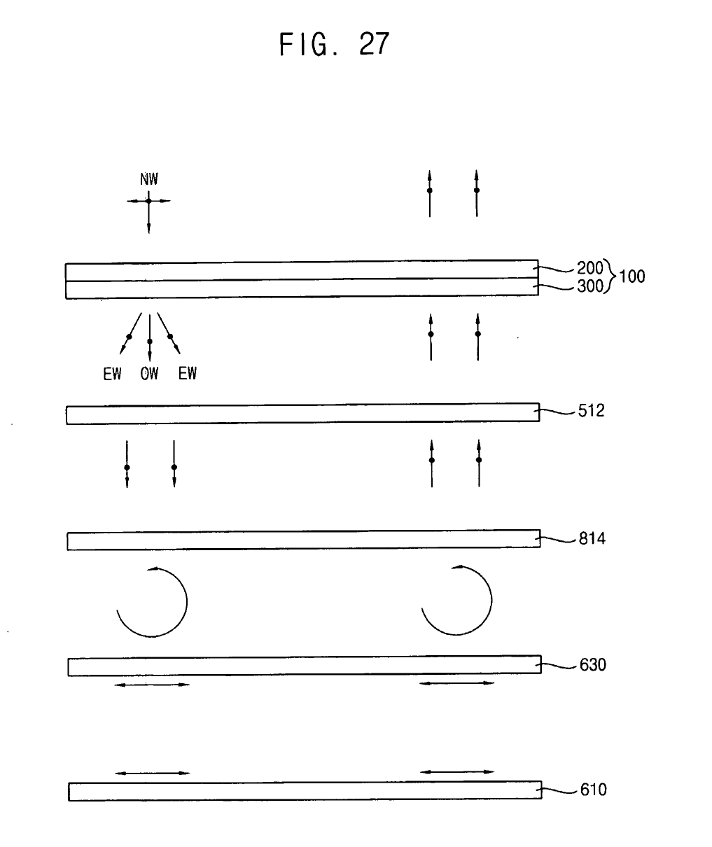

FIG. 27 is a conceptual view illustrating light paths when an electric field is not applied to the display panel of the display panel assembly illustrated in FIG. 26.

Referring to FIG. 27, a natural light wave NW incident from the exterior is divided into an ordinary wave OW with a first polarization state, and an extraordinary wave EW with a second polarization state through a polarization prism film 200 of a polarization compensation film 100. Oscillating directions of the first polarization state and the second polarization state are substantially perpendicular with each other. The ordinary wave OW penetrates a phase difference film 300 of the polarization compensation film 100 maintaining the first polarization state, whereas the extraordinary wave EW with the second polarization state is changed into that with the first polarization state when penetrating the phase difference film 300. Thus, after penetrating the polarization compensation film 100, both the ordinary wave OW and the extraordinary wave EW have the first polarization states.

Because the first polarizing plate 512 has the same transmission axis as that of the first polarization state, after penetrating the polarization compensation film 100, both the ordinary wave OW and the extraordinary wave EW, having the first polarization states, penetrate the first polarizing plate 512.

Waves having the above-mentioned ordinary wave OW and extraordinary wave EW transform phases by λ/4 when passing through the λ/4 film 814. As a result, the waves have circular polarization states rotating counterclockwise.

Thereafter, the waves with the circular polarization states are changed into those with the linear polarization states when passing through the liquid crystal layer 630 in the display panel 600.

After passing through the liquid crystal layer 630, the waves with the linear polarization states are reflected by a reflective electrode 616 of a lower substrate 610. The waves with the linear polarization states reflected by the lower substrate 610 are changed into those with the circular polarization states rotating counterclockwise when penetrating the liquid crystal layer 630.

The waves with the circular polarization states rotating counterclockwise are changed into the waves with the first polarization states having the same transmission axes as that of the first polarizing plate 512 when passing through the λ/4 film 814. The waves pass through the first polarizing plate 512, maintaining the first polarization states. Thereafter, the waves are emitted to the exterior through the polarization compensation film 100, maintaining the first polarization states.

Thus, when an electric field is not applied to the display panel 600, light efficiency is increased through the polarization compensation film 100 so that a reflectivity of the display panel 600 is increased.

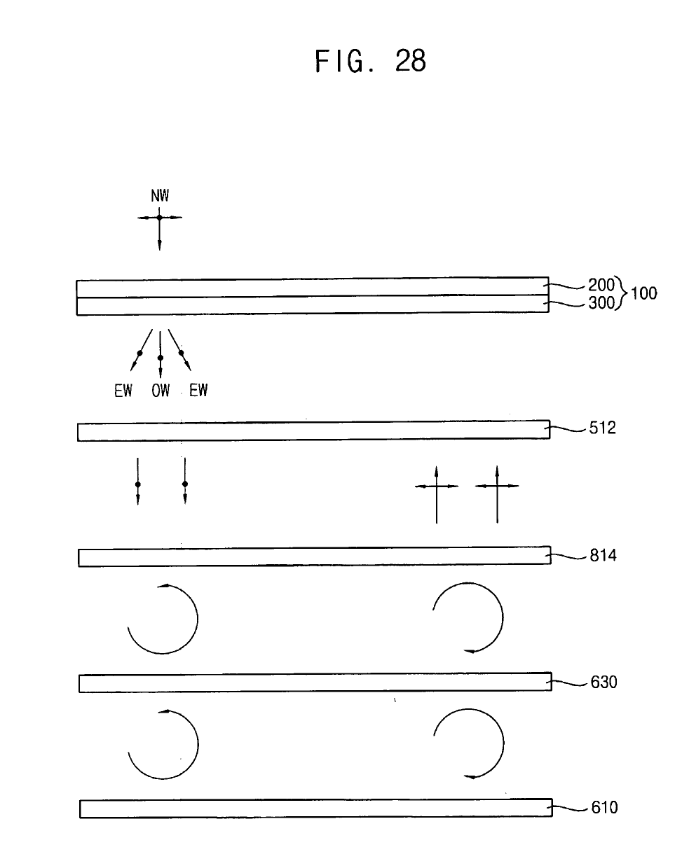

FIG. 28 is a conceptual view illustrating light paths when an electric field is applied to the display panel of display panel assembly illustrated in FIG. 26.

Referring to FIG. 28, a natural light wave NW incident from the exterior is divided into an ordinary wave OW with a first polarization state, and an extraordinary wave EW with a second polarization state through the polarization compensation film 100.

After penetrating the polarization compensation film 100, both the ordinary wave and the extraordinary wave have the same transmission axes as that of the first polarizing plate 512 so that both the ordinary wave and the extraordinary wave penetrate the first polarizing plate 512.

After penetrating the first polarizing plate 512, waves including the above-mentioned ordinary waves OW and extraordinary waves EW transform their phases by λ/4 when passing through the λ/4 film 814. As a result, the waves have circular polarization states rotating counterclockwise.

When an electric field is applied to the display panel 600, phase transformation does not occur through the liquid crystal layer 630. Thus, the waves maintain the circular polarization states when the waves penetrate the liquid crystal layer 630.

After penetrating the liquid crystal layer 630, the waves with the circular polarization states are reflected by the reflective electrode 616 of the lower substrate 610 and the direction of the circular polarization states is changed from counterclockwise to clockwise.

The waves with the circular polarization states rotating clockwise penetrate the liquid crystal layer 630 without changing the polarization states. When penetrating the λ/4 film 814, the waves with the circular polarization states are changed into the waves with linear polarization states having transmission axes perpendicular to that of the first polarizing plate 512. Thus, after penetrating the λ/4 film 814, the waves are absorbed in the first polarization film 512 when the waves penetrate the first polarization film 512.

Accordingly, when the display panel assembly 810 is in a reflective mode, the polarization compensation film 100 improves light efficiency and increases the reflectivity of the display panel 600. On the other hand, when the display panel assembly 810 is in a transmission mode, the polarization compensation film 100 does not affect the display panel assembly 810.

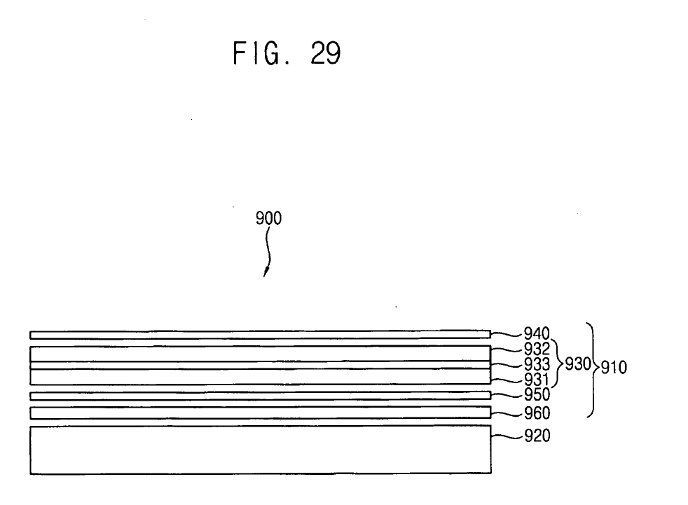

FIG. 29 is a cross-sectional view illustrating a display device in accordance with another example embodiment of the present invention.

Referring to FIG. 29, a display device 900 in accordance with another example embodiment of the present invention includes a display panel assembly 910 and a backlight unit 920.

The display panel assembly 910 includes a display panel 930 displaying an image, a first polarizing plate 940 disposed over the display panel 930, a second polarizing plate 950 disposed under the display panel 930 and a polarization compensation film 960 disposed under the second polarizing plate 950.

In the present example embodiment, the polarization compensation film 960 has a structure that is substantially the same as that of any one of the example embodiments described with reference to FIGS. 1 to 22.

The display panel 930 includes a transmissive panel displaying an image using light from the backlight unit 920.

The display panel 930 includes a lower substrate 931, an upper substrate 932 combined to face the lower substrate 931, and a liquid crystal layer 933 disposed between the lower substrate 931 and the upper substrate 932.

In the present example embodiment, the second polarizing plate 950 is disposed to have a light transmission axis corresponding to a first polarization state. As illustrated in FIGS. 1 to 22, a light wave provided from the backlight unit 920 to the polarization compensation film 960 is divided into an ordinary wave with the first polarization state, and an extraordinary wave with the second polarization state. The extraordinary wave with the second polarization state is changed to that with the first polarization state when the light penetrates the polarization compensation film 960.

Thus, both the ordinary wave OW and the extraordinary wave EW, emitted from the polarization compensation film 960, have the first polarization states. By matching an oscillating direction of the first polarization state to the transmission axis of the second polarizing plate 950, light efficiency provided from the backlight unit 920 is improved and overall luminance is increased.

According to the present invention, a polarization compensation film transmits a wave with a desired polarization state as is. The polarization compensation film changes a wave with an undesired polarization state into a wave with a desired polarization state, and then transmits the wave with the desired polarization state. By using the polarization compensation film, light efficiency may be improved and overall luminance may be increased.

By disposing the polarization compensation film over a reflective or a transflective display panel, light efficiency may be improved.

By disposing the polarization compensation film under a transmissive display panel, efficiency of light provided to a backlight unit may be improved.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A polarization compensation film comprising:
a polarization prism film dividing an incident natural light wave into an ordinary wave with a first polarization state, and an extraordinary wave with a second polarization state that progresses in a direction inclined relative to the ordinary wave; and
a phase difference film changing the second polarization state of the extraordinary wave incident from the polarization prism film into the first polarization state.

2. The polarization compensation film of claim 1, wherein the polarization prism film comprises a first layer and a second layer having different refractive indexes from each other.

3. The polarization compensation film of claim 2, wherein an interface between the first layer and the second layer has a prism shape.

4. The polarization compensation film of claim 3, wherein the ordinary wave goes straight at the interface, and wherein the extraordinary wave is refracted from the interface by a predetermined angle.

5. The polarization compensation film of claim 2, wherein the second layer includes a liquid crystal layer having birefringence characteristics.

6. The polarization compensation film of claim 2, wherein the first layer includes a transparent resin layer.

7. The polarization compensation film of claim 1, wherein the phase difference film includes a liquid crystal layer having birefringence characteristics.

8. The polarization compensation film of claim 7, wherein liquid crystals contained in the liquid crystal layer are positioned inclined to an x-axis on an x-z plane, in which a z-axis indicates a direction substantially parallel with a progressing direction of the ordinary wave, the x-axis indicates a direction substantially parallel with an oscillating direction of the ordinary wave with the first polarization state, and a y-axis indicates a direction substantially perpendicular to the x-z plane.

9. The polarization compensation film of claim 7, wherein the liquid crystals are arranged along a lengthwise direction of a prism-shaped upper portion.

10. The polarization compensation film of claim 8, wherein an angle at which the liquid crystals form with respect to the x-axis is in a range of about 60° to about 70°.

11. The polarization compensation film of claim 9, wherein a thickness of the liquid crystal layer is in a range of about 4 μm to 4.5 μm.

12. The polarization compensation film of claim 7, wherein liquid crystals contained in the liquid crystal layer are arranged to be continuously changed by an angle of about 0° to about 90° with respect to a z-axis on the x-z plane, in which the z-axis indicates a direction substantially parallel with a progressing direction of the ordinary wave, an x-axis indicates a direction substantially parallel with an oscillating direction of the ordinary wave with the first polarization state, and a y-axis indicates a direction substantially perpendicular to x-z plane.

13. The polarization compensation film of claim 12, wherein the liquid crystals are arranged along a lengthwise direction of a prism-shaped upper portion.

14. The polarization compensation film of claim 13, wherein a thickness of the liquid crystal layer is in a range of about 6 μm to 20 μm.

15. The polarization compensation film of claim 1, wherein the phase difference film comprises at least two liquid crystal layers having birefringence characteristics, and wherein the liquid crystals contained in each liquid crystal layer are arranged to be continuously changed by an angle of about 0° to about 90° with respect to a z-axis on an x-z plane, in which the z-axis indicates a direction substantially parallel with a progressing direction of the ordinary wave, an x-axis indicates a direction substantially parallel with an oscillating direction of the ordinary wave with the first polarization state, and a y-axis indicates a direction substantially perpendicular to the x-z plane.

16. The polarization compensation film of claim 15, wherein a transparent adhesion layer is formed between the liquid crystal layers.

17. The polarization compensation film of claim 15, wherein the liquid crystals are arranged along a lengthwise direction of a prism-shaped upper portion.

18. The polarization compensation film of claim 15, wherein the liquid crystals are symmetrically arranged between adjacent liquid crystal layers.

19. The polarization compensation film of claim 15, wherein the liquid crystals are substantially identically arranged in each liquid crystal layer.

20. A method of manufacturing a polarization film comprising:
forming a transparent resin layer that has a prism-shaped upper portion;
forming a lower alignment layer on the transparent resin layer;
rubbing the lower alignment layer;
forming a liquid crystal layer having birefringence characteristics on the lower alignment layer; and
hardening the liquid crystal layer.

21. The method of claim 20, wherein forming the transparent resin layer comprises:
preparing a base film; and
forming a prism layer having a prism shape on the base film.

22. The method of claim 21, wherein a refractive index of the prism layer is substantially the same as that of a minor axis of a liquid crystal contained in the liquid crystal layer.

23. The method of claim 20, wherein an inclination angle of the prism shape is in a range of about 60° to 70°.

24. The method of claim 20, wherein a pitch size of the prism shape is in a range of about 10 μm to 20 μm.

25. The method of claim 20, further comprising thermally treating the lower alignment layer.

26. The method of claim 25, wherein thermally treating the lower alignment layer is performed at a temperature of no more than 130° C.

27. The method of claim 20, wherein the lower alignment layer is rubbed along a direction substantially parallel to a lengthwise direction of the prism-shaped upper portion.

28. The method of claim 20, wherein the lower alignment layer is rubbed along a direction substantially perpendicular to a lengthwise direction of the prism-shaped upper portion.

29. The method of claim 20, wherein the liquid crystal layer is hardened by ultraviolet radiation.

30. A method of manufacturing a polarization film comprising:
forming a transparent resin layer that has a prism-shaped upper portion;
forming a lower alignment layer on the transparent resin layer;
rubbing the lower alignment layer;
forming a liquid crystal layer having birefringence characteristics;
forming a rubbed upper plate having substantially the same rubbing direction as that of the lower alignment layer;
combining the rubbed upper plate with the transparent resin layer, the liquid crystal layer being disposed between the rubbed upper plate and the transparent resin layer; and
hardening the liquid crystal layer.

31. The method of claim 30, further comprising removing the upper plate.

32. The method of claim 30, further comprising thermally treating the lower alignment layer.

33. A display panel assembly comprising:
a display panel displaying an image;
a first polarizing plate disposed over the display panel;
a second polarizing plate disposed under the display panel; and
a polarization compensation film disposed over the first polarizing plate, wherein the polarization compensation film comprises:
a polarization prism film dividing an incident natural light wave into an ordinary wave with a first polarization state, and an extraordinary wave with a second polarization state to form a predetermined angle with respect to the ordinary wave; and
a phase difference film changing the second polarization state of the extraordinary wave incident from the polarization prism film into the first polarization state.

34. The display panel assembly of claim 33, wherein the polarization prism film comprises a first layer and a second layer having different refractive indexes from each other, and wherein an interface between the first layer and the second layer has a prism shape.

35. The display panel assembly of claim 34, wherein the ordinary wave goes straight at the interface, and wherein the extraordinary wave is refracted from the interface by a predetermined angle with respect to the ordinary wave.

36. The display panel assembly of claim 34, wherein the first layer includes a transparent resin layer, and wherein the second layer includes a liquid crystal layer having birefringence characteristics.

37. The display panel assembly of claim 33, wherein the phase difference film includes a liquid crystal layer having birefringence characteristics.

38. The display panel assembly of claim 33, wherein the first polarizing plate includes a light transmission axis corresponding to the first polarization state.

39. The display panel assembly of claim 33, wherein the display panel comprises:
a lower substrate including a reflective region to reflect light incident from the first polarizing plate and a transmissive region to transmit light incident from the second polarizing plate;
an upper substrate combined to face the lower substrate; and
a liquid crystal layer disposed between the lower substrate and the upper substrate.

40. The display panel assembly of claim 39, wherein the lower substrate comprises:
a gate line;
a data line insulated with the gate line, the data line crossing the gate line;
a switching device connected with the gate line and the data line;
a transparent electrode connected with the switching device; and
a reflective electrode connected with the transparent electrode, the reflective electrode forming the reflective region.

41. The display panel assembly of claim 40, wherein the upper substrate comprises:
a color filter layer to produce color; and
a common electrode formed on the color filter layer to face the transparent electrode and the reflective electrode.

42. The display panel assembly of claim 33, further comprising a light-control film disposed over the polarization compensation film, changing a light path of a natural light wave incident from any direction into a direction perpendicular to the polarization compensation film.

43. The display panel assembly of claim 33, further comprising a λ/4 film disposed between the display panel and the first polarizing plate, changing a circular polarization state into a linear polarization state and changing a linear polarization state into a circular polarization.

44. The display panel assembly of claim 33, further comprising a backlight unit disposed under the second polarizing plate, providing light to the second polarizing plate.

45. The display panel assembly of claim 44, wherein the display panel comprises any one selected from the group consisting of a reflective panel and a transflective panel.

46. A display panel assembly comprising:
a display panel displaying an image;
a first polarizing plate disposed over the display panel;
a second polarizing plate disposed under the display panel;
a polarization compensation film disposed under the second polarizing plate; and
a backlight unit disposed under the second polarizing plate, providing light to the second polarizing plate,
wherein the polarization compensation film comprises:
a polarization prism film dividing a natural light wave incident from the backlight assembly into an ordinary wave with a first polarization state corresponding to a light transmissive axis of the second polarizing plate, and an extraordinary wave with a second polarization state progressing to form a predetermined angle with respect to the ordinary wave; and
a phase difference film changing the second polarization state of the extraordinary wave incident from the polarization prism film into the first polarization state.

47. The display panel assembly of claim 46, wherein the display panel includes a transmissive panel.
